(19) United States
(12) Patent Application Publication
(10) Pub. No.: US 2008/0202905 A1
(43) Pub. Date: Aug. 28, 2008

(54) Keyboard with drainage structure

(75) Inventors: Hsien-Wei Juan, Taipei (TW); Chia-Ju Ho, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/709,220

(22) Filed: Feb. 22, 2007

(51) Int. Cl. H01H 13/06

(52) U.S. Cl. 200/302.2; 220/560.03; 220/9.1

(57) ABSTRACT

A keyboard with a waterproof structure disposed in an electronic device is provided, which includes a keyboard key assembly, a waterproof membrane, and a case. The waterproof membrane is assembled on the bottom surface of the keyboard key assembly and the waterproof membrane and the keyboard key assembly are together assembled on the case. A drainage channel is opened along the case, and connected to one side of the waterproof membrane, such that a liquid poured onto the keyboard passes through the keyboard key assembly to flow on the waterproof membrane. Then, the liquid is guided to flow into the drainage channel through the side of the waterproof membrane connected to the drainage channel and afterward flow outside the electronic device through a drainage outlet of the drainage channel, thus preventing the liquid from flowing into the electronic device to cause damage to the electronic device.

### BACKGROUND OF THE INVENTION

1. Field of Invention

The present invention relates to a keyboard structure, and more particularly, to a keyboard with a drainage and waterproof structure.

2. Related Art

When a user is operating on a keyboard while drinking or eating simultaneously, it is hard to avoid liquid being spilled onto the keyboard due to the user's carelessness, which may possibly result in a partial short circuit of the keyboard. If the keyboard is installed on an electronic device, the liquid spilled onto the keyboard may flow into a mainboard of the electronic device, such that the mainboard is usually damaged due to a short circuit caused by the liquid. Thus, the whole electronic device may be damaged and a heavy money loss is resulted.

Therefore, all keyboards employ a protection mechanism. For example, a related art, U.S. Pat. Publication No. 4,948,281, discloses a waterproof protection mechanism of a keyboard. A plurality of keys protrudes from a basic group, a rubber gasket is disposed along the edge of a top surface of the basic group, and a grid support is further assembled on the basic group, such that the rubber gasket is sealed to the edge of the top surface of the basic group to form an accommodation space. A liquid drain passes through the rubber gasket and the grid support to communicate with the accommodation space. When the liquid flows into the accommodation space through the keys, the liquid can then flow out through the liquid drain.

Another related art, U.S. Pat. Publication No. 6,398,436, discloses a waterproof protection mechanism of an electronic device having a keyboard. An absorbent structure is covered on a circuit assembly to absorb liquid spilled onto the keyboard, so as to prevent the liquid flowing to a circuit board assembled in the electronic device. However, the capacity of the absorbent structure is limited, and can merely be used to absorb a small amount of liquid, so if plenty of liquid is poured onto the keyboard, it is impossible for the absorbent structure to achieve a preferred blocking effect.

### SUMMARY OF THE INVENTION

In view of the aforementioned problems, the present invention is directed to provide a keyboard with a drainage structure, so as to successfully drain the liquid poured onto the keyboard.

Therefore, a keyboard with a drainage structure is provided, which is installed in an electronic device, for guiding a liquid to flow out of the electronic device once being poured onto the keyboard. The keyboard with a drainage structure comprises a keyboard key assembly, a waterproof membrane, and a case. The keyboard key assembly has a plurality of gaps between key. The waterproof membrane is disposed on the bottom surface of the keyboard key assembly and has a notch and a drainage side. The waterproof membrane receives the liquid flowing in through the gaps, and guides the liquid into the notch and the drainage side to flow out. The case accommodates the keyboard key assembly and the waterproof membrane, and comprises a drainage channel, an inclined plane, and a drainage outlet. The upper edge of the drainage channel is linked to the drainage side to receive the liquid flowing out of the drainage side. The two ends of the bottom surface of the drainage channel are referred to as a first end and a second end, respectively, in which the first end is higher than the second end. The inclined plane is disposed corresponding to the notch and one side of the inclined plane is connected to one side of the drainage channel, so as to receive and guide the liquid flowing out of the notch to the drainage channel. The drainage outlet is disposed at the second end of the drainage channel and is communicated with the outside of the electronic device, so as to guide the liquid in the drainage channel out of the electronic device.

The cross section of the drainage channel is square slot shaped, which inclines towards one side of the water membrane, so as to guide the liquid into the drainage channel and increase the area of the cross section of the drainage channel, thereby increasing the overall accommodation volume of the drainage channel.

A protruding member protrudes from a portion of the edge of the waterproof membrane towards the keyboard key assembly, and the protruding member contacts a portion of the edge of the keyboard key assembly correspondingly and forms a closed area with the drainage channel.

The edge of the waterproof membrane is partially attached onto the edge of the bottom surface of the keyboard key assembly correspondingly, so as to form a closed area with the drainage channel.

In view of the above, in the present invention, the liquid poured onto the keyboard key assembly is guided to the drainage channel through the waterproof membrane and then drained through the drainage outlet. Therefore, the present invention can achieve the drainage function without making great changes to the original design of the keyboard. In this way, it can be ensured that the electronic device installed with the keyboard may not be completely damaged due to the infiltration of the liquid through the keyboard.

The features and practice of the preferred embodiments of the present invention will be illustrated below in detail with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is an exploded view of the present invention;

FIG. 2 is a schematic stereogram of the drainage channel according to the present invention;

FIG. 3 is a schematic sectional view of FIG. 2 along Line A-A according to the present invention;

FIG. 4 is a schematic stereogram of another embodiment of the drainage channel according to the present invention;

FIG. 5 is a schematic view of another embodiment of the waterproof membrane according to the present invention;

FIG. 6 is a schematic view of still another embodiment of the waterproof membrane according to the present invention; and

FIG. 7 is a schematic view of another embodiment of the case according to the present invention.

### DETAILED DESCRIPTION OF THE INVENTION

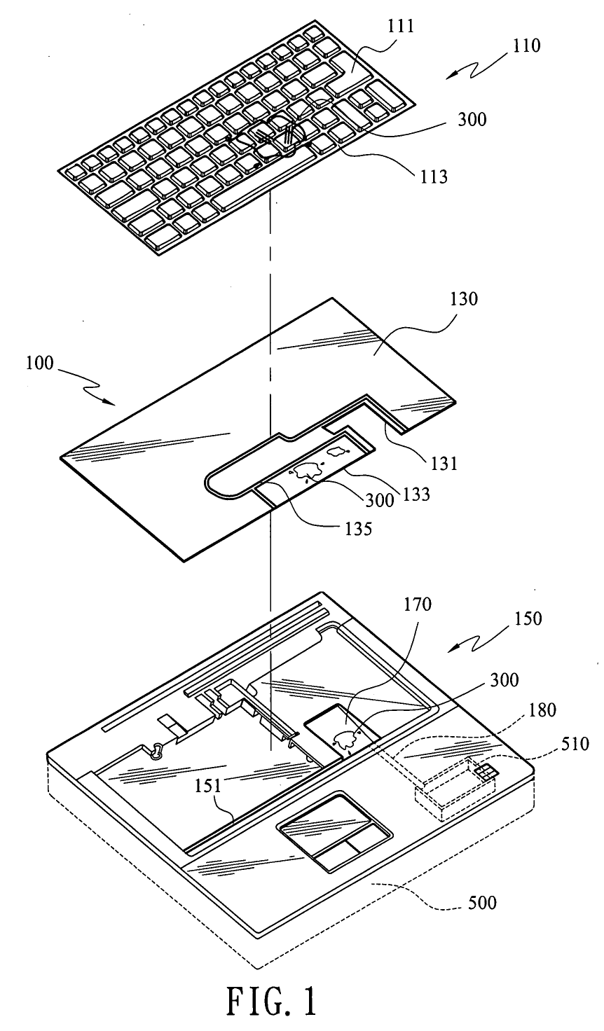

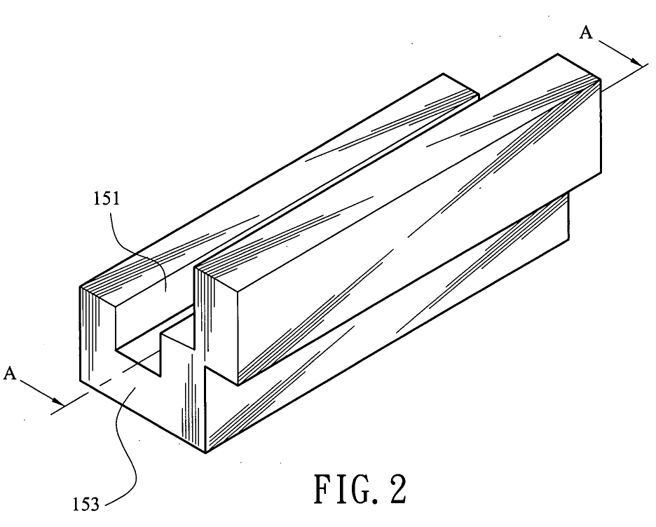

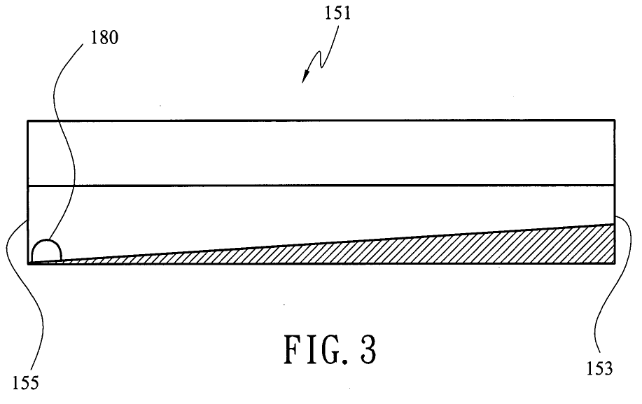

Referring to FIGS. 1, 2, and 3, an exploded view of the present invention, a schematic stereogram of the drainage channel, and a schematic sectional view of FIG. 2 along Line A-A are shown. As shown in FIGS. 1, 2, and 3, the present invention provides a keyboard 100 with a drainage structure installed in an electronic device 500. When a user is operating on the keyboard 100, and a liquid 300, such as a beverage, is spilled onto the keyboard 100 due to the user's carelessness, the liquid 300 is guided to flow out of the electronic device 500, so as to prevent the electronic device 500 from being damaged. The keyboard 100 with a drainage structure includes a keyboard key assembly 110, a waterproof membrane 130, and a case 150.

The keyboard key assembly 110 has a plurality of keys 111, a plurality of gaps 113 between the plurality of keys 111, such that the liquid 300 spilled onto the keys 111 flows to the keyboard key assembly 110 through the gaps 113.

The waterproof membrane 130 is disposed on the bottom surface of the keyboard key assembly 110, and the waterproof membrane 130 has a notch 131 and a drainage side 133. The waterproof membrane 130 receives the liquid 300 flowing in through the gaps 113 and guides the liquid 300 to the notch 131 and the drainage side 133 to flow out.

The case 150 is used to accommodate the keyboard key assembly 110 and a waterproof membrane 130. The case 150 includes a drainage channel 151, an inclined plane 170, and a drainage outlet 180. The upper edge of the drainage channel 151 is linked to the drainage side 133 of the waterproof membrane 130, so as to receive the liquid 300 flowing from the drainage side 133. The two ends of the bottom surface of the drainage channel 151 are referred to as a first end 153 and a second end 155, respectively, in which the first end 153 is higher than the second end 155 to make the height of the bottom surface of the first end 153 of the drainage channel 151 gradually reduced towards the bottom surface of the second end 155, so as to form an inclined shape, and as a result, the liquid 300 flowing into the drainage channel 151 is all guided to flow toward the second end 155. The inclined plane 170 is disposed on the case 150 corresponding to the notch 131 to receive the liquid 300 flowing from the notch 131. One side of the inclined plane 170 is connected to one side of the drainage channel 151, and the side of the inclined plane 170 connected to the drainage channel 151 is lower than the other side opposite to the drainage channel 151, such that the liquid 300 is guided to flow into the drainage channel 151. The drainage outlet 180 is disposed on the second end 155 of the drainage channel 151 and in communication with a peripheral component accommodation slot 510 disposed in the electronic device 500, such as an accommodation slot of a disk drive. The peripheral component accommodation slot 510 is in direct communication with the outside of the electronic device 500, so as to guide the liquid 300 in the drainage channel 151 to flow out of the electronic device 500 through the drainage outlet 180 and the peripheral component accommodation slot 510.

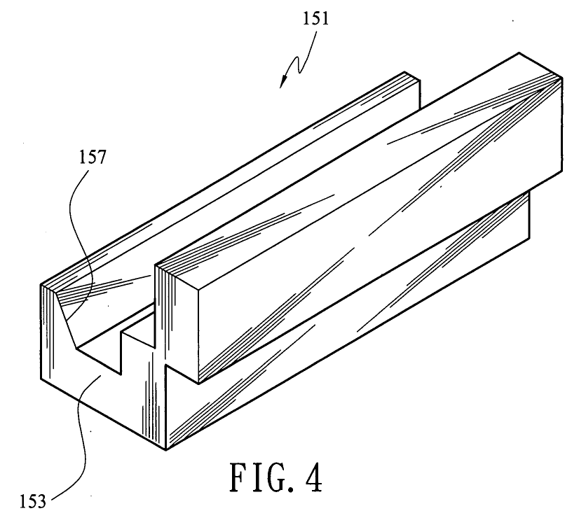

Referring to FIG. 4, a schematic stereogram of another embodiment of the drainage channel is shown. As shown in FIG. 2, the cross section of the drainage channel 151 is square slot shaped. As shown in FIG. 4, the drainage channel 151 in the shape of a square slot inclines toward one side of the waterproof membrane 130 to form an inclined plane 157, so as to guide the liquid 300 into the drainage channel 151 and increase the area of the cross section of the drainage channel 151, thereby increasing the overall accommodation volume of the drainage channel 151.

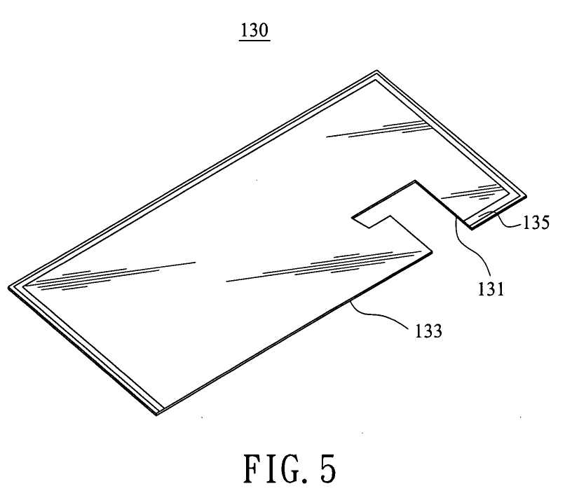

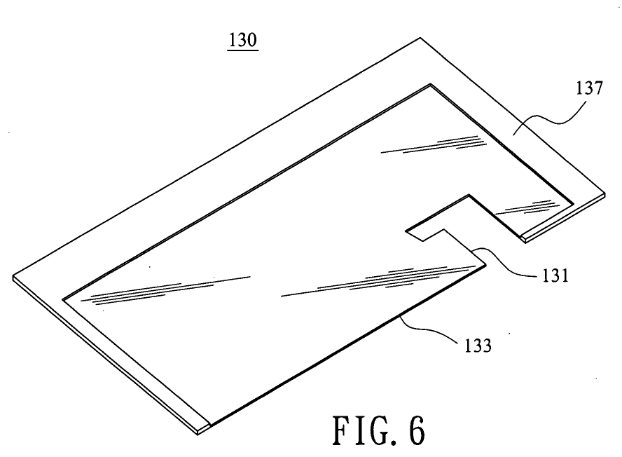

Referring to FIGS. 5 and 6, a schematic view of another embodiment of the waterproof membrane and a schematic view of still another embodiment of the waterproof membrane are shown. As shown in FIG. 1, an adhesive 135 is coated on one side of the waterproof membrane 130 opposite to the keyboard key assembly 110, so as to adhere the waterproof membrane 130 onto the bottom surface of the keyboard key assembly 110. As a result, the waterproof membrane 130 adhered to the keyboard key assembly 110 through the adhesive 135 forms a closed area together with the drainage channel 151, so as to restrict the liquid 300 to flow in this closed area only. In this manner, it is ensured that the liquid 300 can only flow into the drainage channel 151 through the drainage side 133 and the notch 131. In this embodiment, the area that the liquid 300 often flows into the keyboard 100 is selected as the area to be coated with the adhesive 135 for illustration. As shown in FIGS. 1 and 5, the adhesive 135 is coated along the edge of the waterproof membrane 130, but not on the drainage side 133 of the waterproof membrane 130 connected to the drainage channel 151, such that the edge of the waterproof membrane 130 is adhered to the edge of the bottom surface of the keyboard key assembly 110, and forms a closed area with the drainage channel 151, thereby restricting the liquid 300 to flow in the closed area only. As shown in FIGS. 1 and 6, a protruding member 137 protrudes from the edge of the waterproof membrane 130 toward the keyboard key assembly 110, and except that, the drainage side 133 of the waterproof membrane 130 connected to the drainage channel 151 has no such a protruding member 137. When the waterproof membrane 130 and the keyboard key assembly 110 are assembled in the case 150, the protruding member 137 is pressed against a portion of the edge of the keyboard key assembly 110 and forms a closed area with the drainage channel 151, so as to similarly restrict the liquid 300 to flow in the closed area only.

Therefore, the keyboard with a drainage structure provided by the present invention can successfully drain the liquid poured onto the keyboard through the design of the water membrane, the drainage channel, the inclined plane, and the drainage outlet.

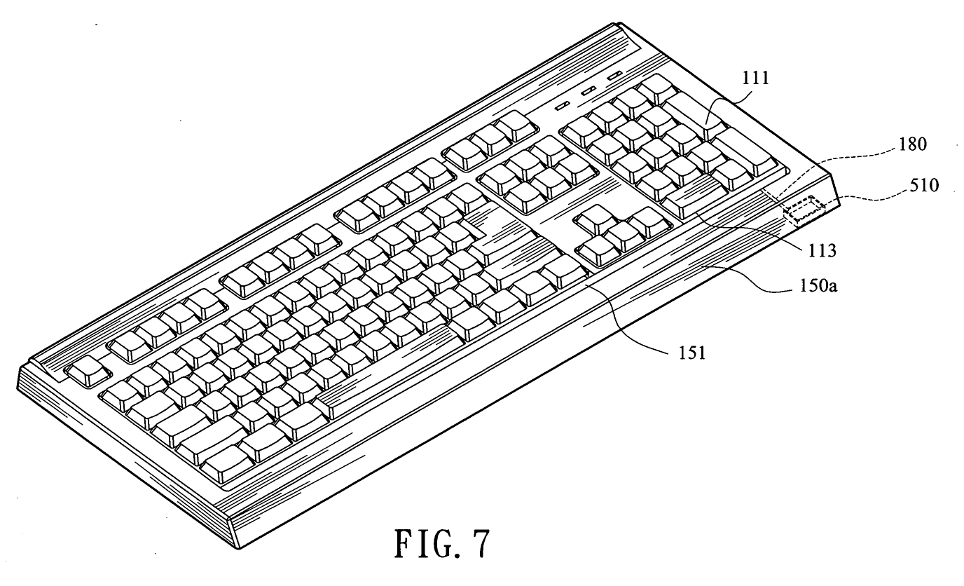

Finally, it can be known from FIG. 1 that the case 150 of the present invention is a portion of the case of the electronic device 500, i.e., the case 150 is formed by extending from the electronic device. Further referring to FIG. 7, another embodiment of the case 150 is shown. It can be seen from the figure that the case 150a is not formed by extending from the electronic device 500, but a single unit independent of the electronic device 500. If the case 150a is to be disposed in the electronic device 500, a buckling assembly (not shown) is disposed at a relative position between the electronic device 500 and the case 150a, so as to combine the two. Furthermore, as for such an implementation manner of the case, the keyboard 100 can also be used independently without being accommodated in the electronic device 500, thus expanding the application scope thereof, for example, applied to areas wherein the liquid is easily spilled in factories or public places.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A keyboard with a drainage structure, installed in an electronic device and for guiding a liquid to flow out of the electronic device after flowing in, the keyboard with a drainage structure comprising:
a keyboard key assembly, having a plurality of gaps between keys;
a waterproof membrane, disposed on a bottom surface of the keyboard key assembly and having a notch and a drainage side, wherein the waterproof membrane receives the liquid flowing in through the gaps and guides the liquid to the notch and the drainage side to flow out; and
a case, accommodating the keyboard key assembly and the waterproof membrane, and comprising:
a drainage channel, an upper edge of the drainage channel being linked to the drainage side to receive the liquid flowing out of the drainage side, two ends of a bottom surface of the drainage channel being referred to as a first end and a second end, respectively, wherein the first end is higher than the second end;
an inclined plane, disposed corresponding to the notch, wherein one side of the inclined plane is connected to one side of the drainage channel, and thus the inclined plane receives and guides the liquid flowing out of the notch to the drainage channel; and
a drainage outlet, disposed at the second end of the drainage channel and in communication with outside of the electronic device, so as to guide the liquid in the drainage channel out of the electronic device.

2. The keyboard with a drainage structure as claimed in claim 1, wherein cross section of the drainage channel is square slot shaped.

3. The keyboard with a drainage structure as claimed in claim 2, wherein the shape of the square slot inclines towards one side of the waterproof membrane, so as to guide the liquid to flow into the drainage channel.

4. The keyboard with a drainage structure as claimed in claim 1, wherein one side of the inclined plane connected to the drainage channel is lower than other side of the inclined plane opposite to the drainage channel.

5. The keyboard with a drainage structure as claimed in claim 1, wherein a protruding member protrudes from a portion of edge of the waterproof membrane towards the keyboard key assembly, and the protruding member contacts a portion of edge of the keyboard key assembly correspondingly and forms a closed area with the drainage channel.

6. The keyboard with a drainage structure as claimed in claim 1, wherein the edge of the waterproof membrane is partially attached to edge of the bottom surface of the keyboard key assembly correspondingly, so as to form a closed area with the drainage channel.

7. The keyboard with a drainage structure as claimed in claim 1, wherein the case is formed by extending from the electronic device.

8. The keyboard with a drainage structure as claimed in claim 1, wherein the case is an independent single unit.

9. A keyboard with a drainage structure, installed in an electronic device, wherein a peripheral component accommodation slot in communication with outside is formed in the electronic device, and when a liquid flows into the keyboard, the liquid is guided to flow out of the peripheral component accommodation slot, the keyboard with a drainage structure comprising:
a keyboard key assembly, having a plurality of gaps between keys;
a waterproof membrane, disposed on a bottom surface of the keyboard key assembly and having a notch and a drainage side, wherein the waterproof membrane receives the liquid flowing in through the gaps and guides the liquid to the notch and the drainage side to flow out; and
a case, accommodating the keyboard key assembly and the waterproof membrane, and comprising:
a drainage channel, wherein the drainage channel inclines toward one side of the waterproof membrane to form an inclined plane to guide the liquid flowing out of the drainage side into the drainage channel and increase area of cross section of the drainage channel, thereby increasing an overall accommodation volume of the drainage channel; and two ends of a bottom surface of the drainage channel are referred to as a first end and a second end, respectively, and the first end is higher than the second end, so as to guide the liquid flowing into the drainage channel to flow toward the second end;
an inclined plane, disposed corresponding to the notch, wherein one side of the inclined plane is connected to one side of the drainage channel, and one side of the inclined plane connected to the drainage channel is lower than other side of the inclined plane opposite to the drainage channel, so as to receive and guide the liquid flowing out of the notch into the drainage channel; and
a drainage outlet, disposed at the second end of the drainage channel and in communication with the peripheral component accommodation slot, so as to guide the liquid in the drainage channel to flow out of the electronic device;
wherein edge of the waterproof membrane is partially attached to edge of the bottom surface of the keyboard key assembly correspondingly, so as to form a closed area with the drainage channel.
